(19) United States
(12) Patent Application Publication
(10) Pub. No.: US 2026/0121819 A1
(43) Pub. Date: Apr. 30, 2026

(54) MECHANISM FOR FULL DUPLEX COMMUNICATIONS

(71) Applicant: Nokia Solutions and Networks Oy, Espoo (FI)

(72) Inventor: Shaofei WANG, Hangzhou (CN)

(21) Appl. No.: 19/166,715

(22) PCT Filed: Mar. 29, 2023
(86) PCT No.: PCT/CN2023/084720

§ 371 Date: Sep. 18, 2025

(51) Int. Cl. H04L 5/14; H04L 27/26

(52) U.S. Cl. CPC H04L 5/14; H04L 27/26

(57) ABSTRACT

Example embodiments of the present disclosure relate to full-duplex communications. A device determines a frequency offset between a first center frequency of a first subband and a second center frequency of a carrier. Within a time duration, the carrier is split into the first subband for reception and at least one second subband for transmission. The first subband includes a set of resource blocks on the carrier. The device also determines a target sampling rate based at least on a subcarrier spacing and the number of resource blocks in the set of resource blocks. The device further processes a signal received on the first subband based on the frequency offset and the target sampling rate. In this way, the sampling rate and the frequency offset can be adaptive to a bandwidth of the first subband, thereby improving the processing of the signal.

### FIELD

Various example embodiments of the present disclosure generally relate to the field of telecommunication and in particular, to methods, devices, apparatuses and computer readable storage medium for full duplex communications.

### BACKGROUND

Communications between devices may be divided into two types, simplex communication and duplex communication. A simplex communication is a communication channel that sends information in one direction only. A duplex communication system is a point-to-point system included two or more connected parties or devices that can communicate with one another in both directions. Duplex systems are employed in many communications networks, either to allow for simultaneous communication in both directions between two connected parties or to provide a reverse path for the monitoring and remote adjustment of equipment in the field. There are two types of duplex communication systems: full-duplex and half-duplex. In some solutions, full-duplex may be a bidirectional type of communication system where two end nodes send and receive data signals at the same time, and a single carrier is simultaneously used for dual communication. In some other solutions, the full-duplex may be a communication system where only one end node is capable of sending and receiving data signals at the same time while the other node is only able to send or receive at the same time. Half-duplex is a mode of communication in which data can be transmitted or received but cannot be transmitted and received simultaneously. Moreover, evolution of new radio (NR) duplex operation has been studied. Therefore, supporting duplex evolution for NR is important.

### SUMMARY

In a first aspect of the present disclosure, there is provided a first apparatus. The first apparatus comprises at least one processor; and at least one memory storing instructions that, when executed by the at least one processor, cause the first apparatus to perform: determining a frequency offset between a first center frequency of a first subband and a second center frequency of a carrier, wherein within a time duration, the carrier is split into the first subband for reception and at least one second subband for transmission, and the first subband comprises a set of resource blocks on the carrier; determining a target sampling rate based at least on a subcarrier spacing and the number of resource blocks in the set of resource blocks; and based on the frequency offset and the target sampling rate, processing a signal that is received on the first subband from a second apparatus.

In a second aspect of the present disclosure, there is provided a second apparatus. The second apparatus comprises at least one processor; and at least one memory storing instructions that, when executed by the at least one processor, cause the second apparatus to perform: transmitting, to a first apparatus, a signal on an uplink subband of a carrier, and wherein within a time duration, the carrier is split into the uplink subband and at least one downlink subband, and the uplink subband comprises a set of resource blocks on the carrier.

In a third aspect of the present disclosure, there is provided a method. The method comprises: at a first apparatus, determining a frequency offset between a first center frequency of a first subband and a second center frequency of a carrier, wherein within a time duration, the carrier is split into the first subband for reception and at least one second subband for transmission, and the first subband comprises a set of resource blocks on the carrier; determining a target sampling rate based at least on a subcarrier spacing and the number of resource blocks in the set of resource blocks; and based on the frequency offset and the target sampling rate, processing a signal that is received on the first subband from a second apparatus.

In a fourth aspect of the present disclosure, there is provided a method. The method comprises: transmitting, at a second apparatus and to a first apparatus, a signal on an uplink subband of a carrier, and wherein within a time duration, the carrier is split into the uplink subband and at least one downlink subband, and the uplink subband comprises a set of resource blocks on the carrier.

In a fifth aspect of the present disclosure, there is provided a first apparatus. The first apparatus comprises means for determining a frequency offset between a first center frequency of a first subband and a second center frequency of a carrier, wherein within a time duration, the carrier is split into the first subband for reception and at least one second subband for transmission, and the first subband comprises a set of resource blocks on the carrier; means for determining a target sampling rate based at least on a subcarrier spacing and the number of resource blocks in the set of resource blocks; and means for based on the frequency offset and the target sampling rate, processing a signal that is received on the first subband from a second apparatus.

In a sixth aspect of the present disclosure, there is provided a second apparatus. The second apparatus comprises means for transmitting, to a first apparatus, a signal on an uplink subband of a carrier, and wherein within a time duration, the carrier is split into the uplink subband and at least one downlink subband, and the uplink subband comprises a set of resource blocks on the carrier.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of subband non-overlapping full duplex (SBFD) slot format during a downlink-SBFD-uplink period according to some example embodiments;

FIG. 3 illustrates examples of DL and UL subband split in SBFD mode according to some example embodiments;

FIG. 4 illustrates a signaling chart for communication according to some example embodiments of the present disclosure;

FIG. 5 illustrates a schematic diagram of subband locations in a carrier according to some example embodiments;

FIG. 6 illustrates an overview architecture of receiver according to some example embodiments;

FIG. 7A and FIG. 7B show schematic diagrams of processing chains according to some example embodiments, respectively;

FIG. 8 illustrates a schematic diagram of fast Fourier transform (FFT) grid and physical resource grid of the subband for SBFD according to some example embodiments;

FIG. 9 illustrates a flowchart of a method implemented at a first device according to some example embodiments of the present disclosure;

FIG. 10 illustrates a flowchart of a method implemented at a second device according to some example embodiments of the present disclosure;

FIG. 11 illustrates a simplified block diagram of a device that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An JAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

The term “carrier” used herein may refer to an electromagnetic wave that can be modulated in frequency, magnitude, or phase to transmit signals. The term “subband” used herein may refer to a set of resources in frequency domain. The term “sampling rate” used herein may refer to the number of samples per second, for example, the unit may be sample per second (sps). In signal processing, sampling is the reduction of a continuous-time signal to a discrete-time signal. The term “subcarrier spacing (SCS)” used herein may refer to a spacing between subcarriers.

As mentioned above, supporting duplex evolution for NR is important. For example, a network device is able to operate in full-duplex mode and a terminal device can operate in half-duplex mode. Moreover, for the network device operating in the full-duplex mode, it might still reside in the full carrier bandwidth for downlink (DL) transmission (TX) processing and uplink (UL) reception (RX) processing. For DL TX, it is straightforward since there might be multiple DL subbands occupying different frequency locations so splitting the carrier into multiplex subbands may bring additional computation complexities. For UL RX, since it is already agreed that only one UL subband is supported and the UL transmission from SBFD-aware UE outside the UL subband are not allowed. In fact, the transmission from non-SBFD-aware UE outside the UL subband may be avoided as well, otherwise, DL TX and UL RX will be activated at same time in overlapping frequency resource, which could give rise to severe UE-UE and gNB-gNB interference issue. As a result, it is predicting that all the UL transmissions are inside the UL subband. From gNB UL receiver perspective, only the frequency resources inside the UL subband may be received, which means that a gNB RX processing chain operating in the full carrier is not efficient. For example, receiver computation complexity may be affected. By way of example, since a gNB receiver is highly relevant to a frequency band size, more computation resources are needed, when the gNB is operating in the full carrier bandwidth and SBFD is activated. Moreover, for certain gNB radio unit (RU) to baseband unit (BBU) split types, time-domain or frequency-domain signal needs to be transferred from RU to BBU, and the data amount is proportional to sampling rate and thus is also to the frequency band size that handled in a gNB receiver. Larger frequency band size requires higher fronthaul processing capability. In addition, due to the fact that TX and RX are activated simultaneously when a gNB is operating in SBFD mode, without advanced RF cross-link cancellation algorithm, DL-UL leakage may bring impact to the system performance in case a gNB UL receiver is operating in the full carrier bandwidth. Therefore, a new solution for supporting the SBFD mode is needed.

According to some example embodiments of the present disclosure, there is provided a solution for supporting the SBFD mode. In this solution, a device determines a frequency offset between a first center frequency of a first subband and a second center frequency of a carrier. Within a time duration, the carrier is split into the first subband for reception and at least one second subband for transmission. The first subband includes a set of resource blocks on the carrier. The device also determines a target sampling rate based at least on a subcarrier spacing and the number of resource blocks in the set of resource blocks. The device further processes a signal received on the first subband based on the frequency offset and the target sampling rate. In this way, the sampling rate and the frequency offset can be adaptive to a bandwidth of the first subband, thereby improving the processing of the signal. Moreover, the signal can be processed more efficiently. Further, the receiver computation complexity may be reduced and less fronthaul interface capacity can be required. In addition, the self-interference may also be reduced.

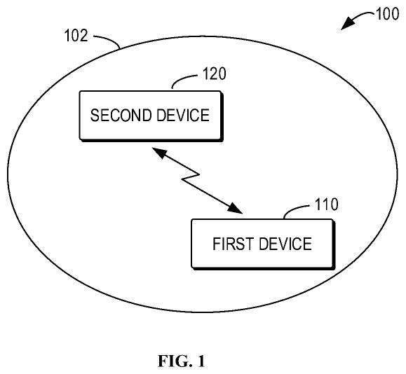

FIG. 1 illustrates an example communication environment 100 in which example embodiments of the present disclosure can be implemented. In the communication environment 100, a plurality of communication devices, including a device 110 and a device 120, can communicate with each other.

In the example of FIG. 1, the device 110 may include a terminal device and the device 120 may include a network device serving the terminal device. The serving area of the device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the device 120 may be other device than a network device. Although illustrated as a terminal device, the device 110 may be other device than a terminal device.

In the following, for the purpose of illustration, some example embodiments are described with the device 110 operating as a terminal device and the device 120 operating as a network device. However, in some example embodiments, operations described in connection with a terminal device may be implemented at a network device or other device, and operations described in connection with a network device may be implemented at a terminal device or other device.

In some example embodiments, if the device 110 is a terminal device and the device 120 is a network device, a link from the device 120 to the device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As shown in FIG. 1, the device 120 is able to operate in SBFD mode. In this situation, a Time Division Duplex (TDD) carrier may be split into at least one DL subband and one UL subband at one time instance (e.g., one slot), which means the device 120 is capable of transmitting in the DL subband(s) and receiving in the UL subband(s) simultaneously. The DL subband(s) and UL subband(s) may be non-overlapping in frequency domain. Compared to conventional TDD operation, SBFD is beneficial for UL coverage enhancement, end-to-end latency reduction as well as system capacity improvement.

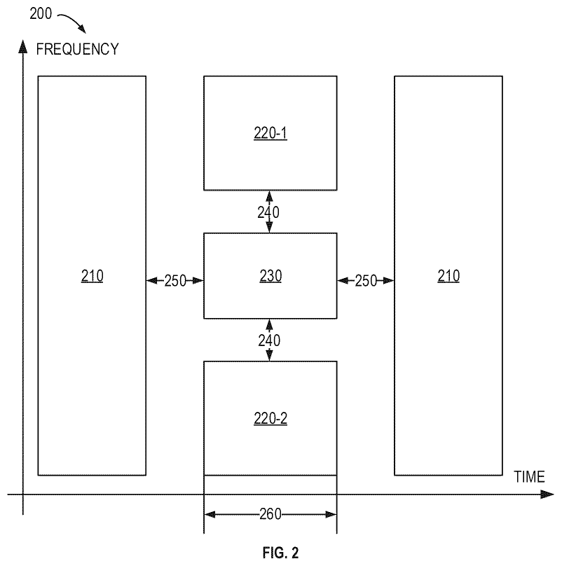

FIG. 2 illustrates a schematic diagram of SBFD slot format 200 during a downlink-SBFD-uplink period according to some example embodiments. As shown in FIG. 2, the full carrier 210 may be used for DL transmission at the beginning and then is tuned into SBFD mode. Within the time duration 260, the full carrier 210 may be spitted into the UL subband 230 and DL subbands 220-1 and 220-2. For example, DL transmission in two DL subbands 220-1 and 220-2 and UL reception in one UL subband 230 are achieved simultaneously. Finally, the whole carrier 220 may be retuned for UL reception only. The potential guard period (GP) 250 inserted in time domain may be necessary for TX-RX switching of a set of gNB antennas and interference mitigation. The potential guard band (GB) 240 inserted in frequency domain may be used to mitigate self-interferences due to simultaneous TX and RX at gNB side. It is noted that the number of UL subbands and the number of DL subbands shown in FIG. 2 are only examples not limitations.

In some example embodiments, for semi-static configuration of subband frequency locations for SBFD operation, at least explicit indication of frequency location of UL subband is required. Further, for indication of subband locations for SBFD operation, semi-static configuration of subband time and frequency location is studied as baseline. For semi-static configuration of subband location, same subband frequency resources across different SBFD symbols may be considered as baseline. In some example embodiments, for semi-static configuration of subband frequency locations for SBFD operation, frequency location of UL/DL subband is with reference to common resource block (CRB) grid.

In some example embodiments, for a SBFD aware UE semi-statically configured with UL subband in a SBFD symbol configured as DL in TDD-UL-DL-ConfigCommon, the following can be followed: (1) UL transmissions within UL subband are allowed in the symbol; (2) UL transmissions outside UL subband are not allowed in the symbol; (3) frequency locations of DL subband(s) are known to the SBFD aware UE; (4) the frequency location of DL subband(s) can be explicitly indicated or implicitly derived; and (5) DL receptions within DL subband(s) are allowed in the symbol. UL transmissions may be within active UL bandwidth part (BWP) and DL receptions are within active DL BWP in the symbol.

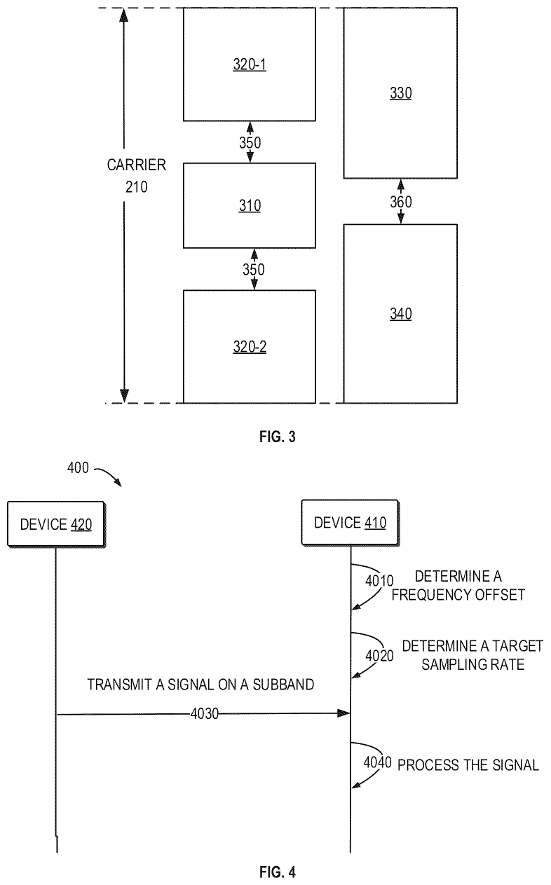

FIG. 3 illustrates examples of DL and UL subband split in SBFD mode according to some example embodiments. For example, in some example embodiments, the carrier 210 may be split into DL subbands 320-1 and 320-2 and an UL subband 310. In this case, the UL subband 310 may be in the middle of the carrier 210 and the DL subbands 320-1 and 320-2 may be located at the bottom and the top of the carrier 210. GBs 350 may be inserted between DL and UL subbands to mitigate interference. It is noted that the into DL subbands 320-1 and 320-2 and the UL subband 310 may include any suitable amounts of resources. Alternatively, in some other example embodiments, the carrier 210 may be split into the UL subband 330 and the DL subband 340. In this case, one GP 360 may be inserted between the DL subband 340 and the UL subband 330. It is noted that the into DL subband 340 and the UL subband 330 may include any suitable amounts of resources. It is noted that the DL/UL subband frequency resource allocation ratio for SBFD mode may be any suitable values. For example, more frequency resources may be allocated to DL considering the fact of DL/UL traffic load imbalance in real networks. By way of example, 80% and 20% of the full carrier frequency resources may be allocated for DL and UL subband, respectively. On the other hand, when the device 120 is operating in SBFD mode, the final implementations of gNB antennas are possibly: a first gNB antenna panel operating in DL TX mode and in DL subband(s) and a second gNB antenna panel operating in UL RX mode and in UL subband. The above TX and RX antenna panels may be designed with high degree of spatial isolation to mitigate gNB self-interference.

Example embodiments of the present disclosure will be described in detail below with reference to the accompanying drawings. Reference is now made to FIG. 4, which shows a signaling chart 400 for communication according to some example embodiments of the present disclosure. As shown in FIG. 4, the signaling chart 400 involves a device 410 and a device 420. By way of example, the apparatus 410 may be implemented at the device 120 or may be the device 120. The apparatus 420 may be implemented at the device 110 or may be the device 110. Although one device 410 and one device 420 are illustrated in FIG. 4, it would be appreciated that there may be a plurality of devices performing similar operations as described with respect to the device 410 below and a plurality of devices performing similar operations as described with respect to the device 420 below. For the purpose of illustrations, FIG. 4 is described with reference to FIGS. 2-3 and FIGS. 5-8 below.

The device 410 is able to operate in full-duplex mode. For example, the device 410 may be operate in SBFD mode. By way of example, the SBFD slot format 200 may be configured at the device 410. The bandwidth of the carrier 210 can be configured at the device 410. The way of splitting the carrier 210 may also be configured. For example, if the carrier 210 is split into DL subbands 320-1 and 320-2 and an UL subband 310, the number of resources in the UL subband 310 and the number of resources in DL subbands 320-1 and 320-2 may be configured at the device 410. In addition, the GBs 350 may be configured at the device 410 as well. In another example, if the carrier is split into the UL subband 330 and the DL subband 340, the number of resources in the UL subband 330, the number of resources in DL subbands 340, and the GB 360 may be configured at the device 410. It is noted that the number of resource blocks in each subband and the GB may be any suitable numbers.

In some example embodiments, the device 410 may be configured with a plurality of SBFD slot formats. For example, in some embodiments, the bandwidths of UL subbands and/or the bandwidths of the DL subbands may be different in the plurality of SBFD slot formats. Alternatively, the timings of splitting the carrier may be different in the plurality of SBFD slots formats.

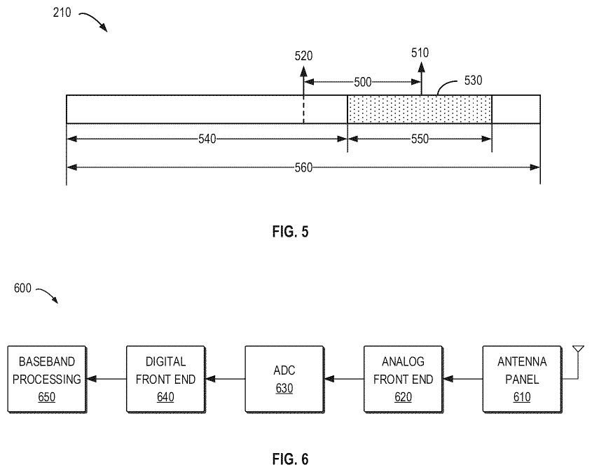

The subband for SBFD may include a set of resource blocks in frequency domain. For example, as shown in FIG. 5, the subband 530 may include a set 550 of the resource blocks. By way of example, two parameters can be utilized to control the frequency location of the UL subband with respect to the full carrier, which are the start resource block

$$( {N}_{Start}^{UL} )$$

and number of RBs

$$( {N}_{RB}^{UL} ) ,$$

respectively. For example, as shown in FIG. 5, the start resource block (represented as “540”) and the number of resource blocks may be used to determine the frequency location of the subband 530. In other words, the subband 530 may start at the resource block

$${N}_{Start}^{UL}$$

and include

$${N}_{RB}^{UL}$$

resource blocks. The number of resource blocks (560) in the carrier 510 may be N_{RB}. In this case, a resource block ratio α between the carrier 210 and the subband 530 may be

$${N}_{RB} / {N}_{RB}^{UL} .$$

In some example embodiments, the resource block ratio α may be between 2 and 8, i.e., 8≥α≥2. The location of the subband 530 may be flexibly configured in the carrier 210 for SBFD mode. It is noted that the location of the subband 530 shown in FIG. 5 is only an example not limitation.

The device 410 determines (4010) a frequency offset between a center frequency (referred to as “first frequency center” hereinafter) of a subband (for example, an uplink subband) and a center frequency (referred to as “second frequency center” hereinafter) of the carrier. For example, as shown in FIG. 5, the frequency offset 500 between the center frequency 510 of the subband 530 and the center frequency 520 of the carrier 560 may be determined by the device 410. In some embodiments, the frequency offset may be determined dynamically. Alternatively, the frequency offset may be determined in advance. It is noted that the frequency offset may be determined based on any proper approach. In this case, the signal may be shifted in frequency domain to the center of the subband instead of the full carrier. Only as an example, the frequency offset 500 (in Hz) may be obtained as:

$$Δ f = {f}_{s} - {f}_{c} = ( {N}_{sc}^{RB} \times {N}_{Start}^{UL} + ( {N}_{sc}^{RB} / 2 ) \times {N}_{RB}^{UL} - ( {N}_{sc}^{RB} / 2 ) \times {N}_{RB} ) \times {N}_{Band} \qquad ( 1 )$$

where Δf represents the frequency offset 500, fₛ represents the center frequency 510, f_{c} represents the center frequency 520,

$${N}_{Start}^{UL}$$

represents the start resource block of the subband 530,

$${N}_{RB}^{UL}$$

represents the number of resource blocks in the subband 530, N_{RB} represents the number of resource blocks in the carrier 210, N_{Band} represents the SBS for the carrier 210,

$${N}_{sc}^{RB}$$

represents the number of subcarriers per resource block, which is also commonly defined by 3GPP. For example,

$${N}_{sc}^{RB}$$

may be 12.

The device 410 determines (4020) a target sampling rate based at least on a SCS and the number of resource blocks in the set of resource blocks. For example, the SCS may be one of: 15 kHz, 30 kHz, 60 kHz, 240 kHz, or 480 kHz. In this way, the target sampling rate may be reduced substantially, so that computation resources for baseband and radio frequency processing could be reduced accordingly.

In an example embodiment, the device 410 may determine an operation carrier bandwidth. For example, the operation carrier bandwidth may be a minimal operation carrier with a SCS that is same as the SCS of the carrier (for example, the carrier 210). By way of example, if the SCS of the carrier is 30 kHz, the SCS of the operation carrier bandwidth is also 30 kHz. In addition, a resource block number (represented as “

$$( represented as “ {N}_{RB}^{O} ) ” )$$

”) of the operation carrier bandwidth may be larger than the number of resource block

$$( i . e . , {N}_{RB}^{UL} )$$

in the set of resource blocks. By way of example, the operation carrier bandwidth may be determined from a transmission bandwidth configuration. The device 410 may further determine the target sampling rate based on the operation carrier bandwidth and a sampling rate of the carrier. In some example embodiments, a ratio between the sampling rate (represented as “S_{c}”) of the carrier and the target sampling rate (represented as “Sₜ”) may satisfy power of two. For example, in some situations, only down-sampling ratio of power-of-two may be allowed. In other words, the ratio between the sampling rate of the full carrier (S_{c}) and the target sampling rate (Sₜ) follow may power-of-two, which is S_{c}/Sₜ=2^{k}, k=0, 1, 2, . . . . In this way, since the operational bandwidth is designed according to the subband size, the potential self-interference can be reduced from RF processing chain.

In some example embodiments, the target sampling rate may be determined based on Table 1 below. It is noted that the target sampling rate can be determined using any proper approach and Table 1 is only an example not limitation.

TABLE 1

| | 5 | 10 | 15 | 20 | 25 | 30 | 35 | 40 | 45 | 50 | 60 | 70 | 80 | 90 | 100 |
|---|---|---|---|---|---|---|---|---|---|---|---|---|---|---|---|
| SCS | MHz | MHz | MHz | MHz | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 188 | 216 | 242 | 270 | N/A | N/A | N/A | N/A | N/A |
| 30 | 11 | 24 | 38 | 51 | 65 | 78 | 92 | 106 | 119 | 133 | 162 | 189 | 217 | 245 | 273 |
| 60 | N/A | 11 | 18 | 24 | 31 | 38 | 44 | 51 | 58 | 65 | 79 | 93 | 107 | 121 | 135 |

Taking 30 KHz SCS, and 100 MHz carrier bandwidth as an example, the available resource block number is 273 which can be obtained from Table 1. Assuming

$${N}_{RB}^{UL} = 64 ,$$

then the operational carrier bandwidth is 25 MHz since

$${N}_{RB}^{O} ( 65 ) > {N}_{RB}^{UL} ( 64 ) ,$$

as shown in Table 1. The target sampling rate for 100 MHz and 25 MHz carrier bandwidth can be 122.88 Msps and 30.72 Msps, respectively. As a result, the target sampling rate may be set as 30.72 Msps, which means the time interval of the signal is ˜32.55 nanoseconds.

The device 420 transmits (4030) a signal on the subband of the carrier to the device 410. For example, the device 410 receives the signal on the subband 530 of the carrier 210 from the device 420.

The device 410 processes (4040) the signal based on the frequency offset and the target sampling rate. For example, the frequency offset and the target sampling rate may affect one or more steps of the processing procedure. In this way, the computation resources for baseband and radio frequency processing may be reduced accordingly.

By way of example, the receiver architecture 600 as shown in FIG. 6 may be implemented at the device 410. As shown in FIG. 6, the signal transmitted (4030) from the device 420 may be received by an antennal panel 610. The signal may be further passed through an analog front end (AFE) module 620. In the AFE module 620, the signal may be amplified by low noise amplifier (LNA) and down-converted by local oscillator (LO). Analog beamforming with phase shifters can also be executed in analog domain. The device 410 may apply an analogue to digital conversion to the signal using an analog-to-digital convertor (ADC) 630. In this case, the signal is converted to digital domain.

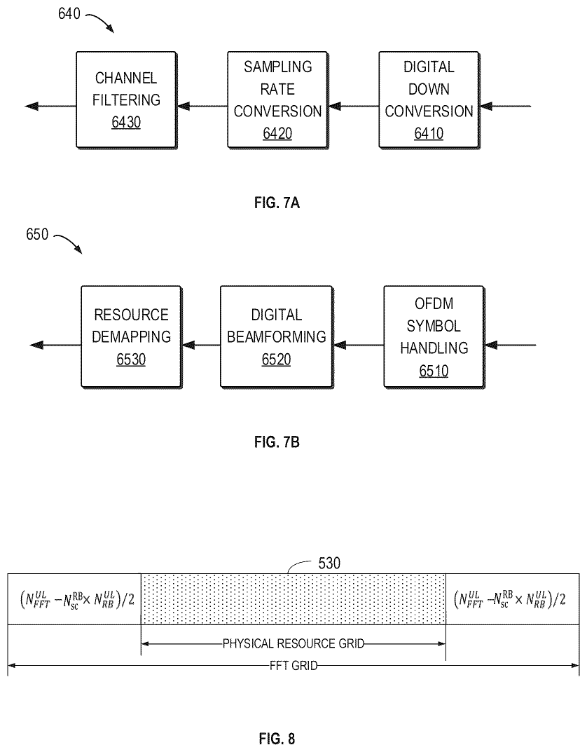

The device 410 may apply a digital front end (DFE) process to the signal based on the frequency offset and the target sampling rate. In this case, the signal may be further processed by a DFE module 640 based on the frequency offset and the target sampling rate. For example, the device 410 may shift a zero-frequency of the signal to the center frequency 510 of the subband 530 according to the frequency offset. In some example embodiments, as shown FIG. 7A, the DFE module 640 may also include a digital down conversion (DDC) module 6410, a sampling rate conversion (SRC) module 6420, and a channel filtering module 6430. In other words, the DFT module 640 may perform one or more of: a signal level control, a digital down conversion, a sampling rate conversion (SRC), or a channel filtering to the signal. It is noted that the DFE module 640 may also include one or more other modules which are not shown in FIG. 7A.

In some example embodiments, the signal may be down-converted into baseband signal in the DDC 6410 based on the frequency offset. The frequency offset can be implemented by using Numerically Controlled Oscillators (NCOs). The signal may be transferred into the SRC module 6420, in order to following channel filtering and down sampling. In this case, the device 410 may perform a down sampling on the signal according to the target sampling rate. For example, according to the target sampling rate (Sₜ), down-sampling ratio may be updated and further down sampling may be implemented in SRC module. The SRC module 6420 may include cascaded integrator-comb filter and half-band filter, so that different down-sampling ratios can be naturally supported.

In addition, the operational carrier bandwidth may be the target channel bandwidth to choose a suitable channel filter. As a result, the output signal from DFE module 640 may be a time-domain discrete signal with the target sampling rate of Sₜ and zero-frequency located at the center frequency 510 of the subband 530 by using the frequency offset 500. In this way, since the operational bandwidth is designed according to the subband size, the potential self-interference can be reduced from RF processing chain.

The device 410 may apply a baseband process to the signal based on the target sampling rate. For example, the baseband process may include orthogonal frequency-division multiplexing (OFDM) symbol handling functionalities (for example, cyclic prefix (CP) removal, fast Fourier transform (FFT) operation and phase compensation and the like), digital beamforming (DBF) and the following frequency-domain processing (i.e., physical resource demapping, channel estimation, parameter estimation, equalizer, soft-bit calculations and decoder and the like). As shown in FIG. 7B, the baseband processing module 650 may include an OFDM symbol handling module 6510, a digital beamforming module 6520, and a resource demapping module 6530. It is noted that the baseband processing module 650 may also include one or more other modules which are not shown in FIG. 7b. The BB processing before resource demapping may be dependent on the frequency bandwidth. For example, the size of CP and FFT implemented in OFDM symbol handling module is proportional to frequency bandwidth.

In some example embodiments, the device 410 may determine a time-domain signal measurement based on the target sampling rate. For example, the measurement of received signal strength indicator (RSSI) may be determined based on the target sampling rate. The device 410 may also determine a time-domain signal process based on the target sampling rate. For example, since the target sampling rate is changed, the amount of sampled data of the signal may also be changed. Alternatively, or in addition, the device 410 may determine a parameter estimation, or a beamforming process based on the target sampling rate. For example, the parameter related to bandwidth may be determined based on the target sampling rate.

In some other example embodiments, the device 410 may determine CP based on the target sampling rate and the sampling rate of the carrier. For example, the CP may be determined as:

$${N}_{CP}^{UL} = \frac{{N}_{CP} \times {S}_{t}}{{S}_{c}} where {N}_{CP}^{UL} \qquad ( 2 )$$

represents the determined CP, N_{CP} represents the CP of the full carrier, Sₜ represents the target sampling rate and S_{c} represent the sampling rate of the full carrier.

Alternatively, or in addition, the device 410 may determine a FFT size based on the target sampling rate and the sampling rate of the carrier. For example, the FFT size may be determined as:

$${N}_{FFT}^{UL} = \frac{{N}_{FFT} \times {S}_{t}}{{S}_{c}} where {N}_{FFT}^{UL} \qquad ( 3 )$$

represents the determined FFT size, N_{FFT} represents the FFT size of the full carrier, Sₜ represents the target sampling rate and S_{c} represent the sampling rate of the full carrier. Table 2 shows examples of CP and FFT size of the full carrier and the operational carrier bandwidth. It is noted that Table 2 is only an example not limitation.

TABLE 2

| OFDM symbol in a slot | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| N_{CP} | 352 | 288 | 288 | 288 | 288 | 288 | 288 | 288 | 288 | 288 | 288 | 288 | 288 | 288 |
| N_{CP}^{UL} | 88 | 72 | 72 | 72 | 72 | 72 | 72 | 72 | 72 | 72 | 72 | 72 | 72 | 72 |

| | |
|---|---|
| N_{FFT} | 4096 |
| N_{FFT}^{UL} | 1024 |

For example, as shown in Table 2, the CP and the FFT size can be reduced by a factor of four compared with those of the full carrier.

Alternatively, or in addition, the device 410 may determine frequency resources for the subband (for example, the subband 530) based on a frequency relationship between the subband and the carrier (for example, the carrier 210). For example, the signal after FFT operation may be mapped into a FFT grid (in granularity of SCS), and then valid physical resources located at the center of the carrier may be extract ed for the following processing. For example, as shown in FIG. 8, if the device 410 is operating the subband 530 in SBFD mode, the frequency resources of the subband 530 may be extracted by removing

$$( {N}_{FFT}^{UL} - {N}_{sc}^{RB} \times {N}_{RB}^{UL} ) / 2$$

subcarriers from both sides of the FFT grid, where

$${N}_{sc}^{RB}$$

represents the number of subcarriers per resource block, which is also commonly defined by 3GPP, for example,

$${N}_{sc}^{RB}$$

may be 12. The valid frequency signal may be sent to DBF module.

In some example embodiments, in a TDD carrier with massive multiple-input and multiple-output (MIMO) deployment, sounding reference signal (SRS) may be typically utilized to acquire the DL/UL channel state information. In this case, SRS processing may also be considered in the module, where the only impact is the SRS resource demapping. The original SRS frequency (resource element) locations calculated based on the full carrier, e.g., l₀, l₁, l₂, . . . , may be translated into

$$( {l}_{0} , {l}_{1} , {l}_{2} , … ) - {N}_{sc}^{RB} \times {N}_{Start}^{UL}$$

in case the UL subband is operated for SBFD, where

$${N}_{sc}^{RB}$$

represents the number of subcarriers per resource block, which is also commonly defined by 3GPP, for example,

$${N}_{sc}^{RB}$$

may be 12. And the same rule may be followed in the resource demapping module for other physical channels and signals.

In some example embodiments, an entire receiver may be split into radio unit (RU) processing and baseband unit (BBU) processing, and they can be communicated by a fronthaul interface. Different split options are proposed, where the signals transferred from fronthaul are different. A key capacity requirement for fronthaul processing may be the number of amount of data that needs be transferred from RU to BBU. For example, three split options may be applied in case the device 410 is operating in the UL subband for SBFD. In this way, it can reduce the need of fibers.

For example, if DFE processing chain is deployed in RU and BB processing is deployed in BBU, the data transferred from RU to DU is the time-domain discrete signal with a certain sampling rate. In this situation, the target sampling rate which is lower than that of the full carrier and is with less number of samples may be beneficial for fronthaul processing.

Alternatively, if the RU processing is up to OFDM symbol handling module and the remaining functionalities reside in BBU, the data transferred from RU to BBU is the frequency-domain signal before DBF. In this situation, the amount of data may be reduced in case the device 410 is operating in the UL subband width less frequency resources.

In some other embodiments, if RU processing is up to DBF module and the remaining functionalities reside in BBU, the data transferred from RU to BBU is also the frequency-domain signal. In this situation, the amount of data may be reduced in case the device 410 is operating in the UL subband width less frequency resources.

According to embodiments described with reference to FIGS. 2-8, the frequency offset value and the target sampling rate value associated with the subband of the carrier may be determined. Specifically, the frequency offset value is determined based on the UL subband frequency location with respect to the carrier bandwidth. In addition, the target sampling rate value may be determined by choosing the corresponding sampling rate for an operational carrier bandwidth, for example, to satisfy, the available RB number of the operational carrier larger than UL subband size and/or the ratio between the sampling rate of the full carrier and that of the operational carrier follow power-of-two. In this case, the signal is processed based on the determined frequency offset and the target sampling rate. For example, in DFE processing chain, the frequency offset value could be implemented in DDC module in DFE and the target sampling rate could be implemented in SRC module in DFE. Alternatively, or in addition, in baseband processing chain, sampling rate impact to the time-domain signal measurements and parameter estimations may be be considered. For example, CP/FFT size inside the OFDM symbol handling module may be be calculated based on the ratio of the sampling rate between the operational carrier and the full carrier. The frequency resource relationship between UL subband and the full carrier may be considered in the physical channel resource demapping, in DBF module and resource demapping module. In this way, the computation resources for baseband and radio frequency processing may be reduced accordingly. Further, the fronthaul capacity may also be saved in certain gNB fronthaul interface types. Additionally, since the operational bandwidth is designed according to the UL subband size, the potential gNB self-interference could be reduced from RF processing chain.

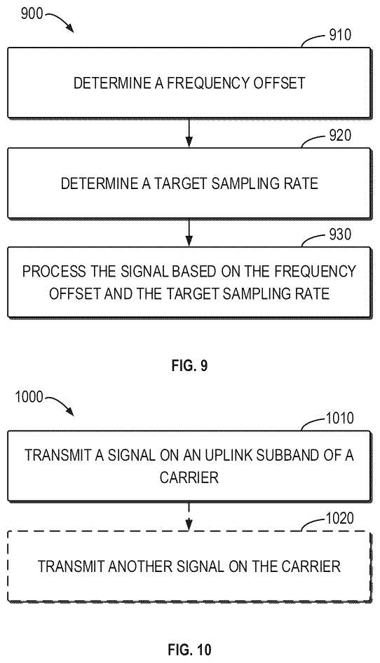

FIG. 9 shows a flowchart of an example method 900 implemented at a first apparatus in accordance with some example embodiments of the present disclosure. For the purpose of discussion, the method 900 will be described from the perspective of the device 120 in FIG. 1.

At block 910, the device 120 determines a frequency offset between a first center frequency of a first subband and a second center frequency of a carrier. Within a time duration, the carrier is split into the first subband for reception and at least one second subband for transmission. In this case, the first subband comprises a set of resource blocks on the carrier.

At block 920, the device 120 determines a target sampling rate based at least on a subcarrier spacing and the number of resource blocks in the set of resource blocks. In some example embodiments, the device 120 may determine an operation carrier bandwidth with a same subcarrier spacing as the carrier. In this case, a resource block number of the operation carrier bandwidth may be larger than the number of resource block in the set of resource blocks. The device 120 may further determine the target sampling rate based on the operation carrier bandwidth and a sampling rate of the carrier. In some example embodiments, a ratio between the sampling rate of the carrier and the target sampling rate satisfies power of two.

At block 930, the device 120 processes a signal that is received on the first subband from a second apparatus, based on the frequency offset and the target sampling rate. In some example embodiments, the device 120 may apply a digital front end process to the signal based on the frequency offset and the target sampling rate. In some example embodiments, after an analogue to digital conversion is applied to the signal, the device 120 may shift a zero-frequency of the signal to the first center frequency of the first subband according to the frequency offset. In some example embodiments, the device 120 may perform a down sampling on the signal according to the target sampling rate.

In some example embodiments, the device 120 may apply a base band process to the signal based on the target sampling rate. In some example embodiments, the device 120 may determine, based on the target sampling rate, at least one of: a time-domain signal measurement, a time-domain signal process, a parameter estimation, or a beamforming process. In some example embodiments, the device 120 may determine, based on the target sampling rate and the sampling rate of the carrier, at least one of: a cyclic prefix or a fast Fourier transform size. In some example embodiments, the device 120 may determine frequency resources for the first subband based on a frequency relationship between the first subband and the carrier.

FIG. 10 shows a flowchart of an example method 1000 implemented at a second apparatus in accordance with some example embodiments of the present disclosure. For the purpose of discussion, the method 1000 will be described from the perspective of the device 110 in FIG. 1.

At block 1010, the device 110 transmits to the device 120, a signal on an uplink subband of a carrier. Within a time duration, the carrier is split into the uplink subband and at least one downlink subband. The uplink subband comprises a set of resource blocks on the carrier. Alternatively, the device 110 may receive another signal on at least one subband of the carrier within the time duration, instead of transmitting the signal. In some embodiments, at block 1020, the device 110 may transmit a further signal on the carrier to the device 120.

In some example embodiments, a first apparatus capable of performing any of the method 900 (for example, the device 120 in FIG. 1) may comprise means for performing the respective operations of the method 900. The means may be implemented in any suitable form. For example, the means may be implemented in a circuitry or software module. The first apparatus may be implemented as or included in the device 120 in FIG. 1.

In some example embodiments, the first apparatus comprises means for determining a frequency offset between a first center frequency of a first subband and a second center frequency of a carrier, wherein within a time duration, the carrier is split into the first subband for reception and at least one second subband for transmission, and the first subband comprises a set of resource blocks on the carrier; means for determining a target sampling rate based at least on a subcarrier spacing and the number of resource blocks in the set of resource blocks; and means for based on the frequency offset and the target sampling rate, processing a signal that is received on the first subband from a second apparatus.

In some example embodiments, the first apparatus comprises means for determining an operation carrier bandwidth with a same subcarrier spacing as the carrier, and wherein a resource block number of the operation carrier bandwidth is larger than the number of resource block in the set of resource blocks; and means for determining the target sampling rate based on the operation carrier bandwidth and a sampling rate of the carrier.

In some example embodiments, a ratio between the sampling rate of the carrier and the target sampling rate satisfies power of two.

In some example embodiments, the first apparatus comprises means for applying a digital front end process to the signal based on the frequency offset and the target sampling rate.

In some example embodiments, the first apparatus comprises means for after an analogue to digital conversion is applied to the signal, shifting a zero-frequency of the signal to the first center frequency of the first subband according to the frequency offset.

In some example embodiments, the first apparatus comprises means for performing a down sampling on the signal according to the target sampling rate.

In some example embodiments, the first apparatus comprises means for applying a base band process to the signal based on the target sampling rate.

In some example embodiments, the first apparatus comprises means for determining, based on the target sampling rate, at least one of: a time-domain signal measurement, a time-domain signal process, a parameter estimation, or a beamforming process.

In some example embodiments, the first apparatus comprises means for determining, based on the target sampling rate and the sampling rate of the carrier, at least one of: a cyclic prefix or a fast Fourier transform size.

In some example embodiments, the first apparatus comprises means for determining frequency resources for the first subband based on a frequency relationship between the first subband and the carrier.

In some example embodiments, and the second apparatus comprises a terminal device.

In some example embodiments, the first apparatus further comprises means for performing other operations in some example embodiments of the method 900 or the device 120. In some example embodiments, the means comprises at least one processor; and at least one memory storing instructions that, when executed by the at least one processor, cause the performance of the first apparatus.

In some example embodiments, a second apparatus capable of performing any of the method 1000 (for example, the device 110 in FIG. 1) may comprise means for performing the respective operations of the method 1000. The means may be implemented in any suitable form. For example, the means may be implemented in a circuitry or software module. The second apparatus may be implemented as or included in the device 110 in FIG. 1.

In some example embodiments, the second apparatus comprises means for transmitting, to a first apparatus, a signal on an uplinksubband of a carrier, and wherein within a time duration, the carrier is split into the uplink subband and at least one downlink subband for reception, and the uplink subband comprises a set of resource blocks on the carrier.

In some example embodiments, and the second apparatus comprises a terminal device.

In some example embodiments, the second apparatus further comprises means for performing other operations in some example embodiments of the method 1000 or the device 110. In some example embodiments, the means comprises at least one processor; and at least one memory storing instructions that, when executed by the at least one processor, cause the performance of the second apparatus.

FIG. 11 is a simplified block diagram of a device 1100 that is suitable for implementing example embodiments of the present disclosure. The device 1100 may be provided to implement a communication device, for example, the device 110 or the device 120 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The instructions of the program 1130 may include instructions for performing operations/acts of some example embodiments of the present disclosure. The program 1130 may be stored in the memory, e.g., the ROM 1124. The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIG. 2 to FIG. 10. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 12 shows an example of the computer readable medium 1200 which may be in form of CD, DVD or other optical storage disk. The computer readable medium 1200 has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus to perform:
determining a frequency offset between a first center frequency of a first subband and a second center frequency of a carrier, wherein within a time duration, the carrier is split into the first subband for reception and at least one second subband for transmission, and the first subband comprises a set of resource blocks on the carrier;
determining a target sampling rate based at least on a subcarrier spacing and the number of resource blocks in the set of resource blocks; and
based on the frequency offset and the target sampling rate, processing a signal that is received on the first subband from a second apparatus.

2. The first apparatus of claim 1, wherein the instructions, when executed by the at least one processor, cause the first apparatus to perform:
determining an operation carrier bandwidth with a same subcarrier spacing as the carrier, and wherein a resource block number of the operation carrier bandwidth is larger than the number of resource block in the set of resource blocks; and
determining the target sampling rate based on the operation carrier bandwidth and a sampling rate of the carrier.

3. The first apparatus of claim 2, wherein a ratio between the sampling rate of the carrier and the target sampling rate satisfies power of two.

4. The first apparatus of any of claim 1, wherein the instructions, when executed by the at least one processor, cause the first apparatus to perform:
applying a digital front end process to the signal based on the frequency offset and the target sampling rate.

5. The first apparatus of claim 4, wherein the instructions, when executed by the at least one processor, cause the first apparatus to perform:
after an analogue to digital conversion is applied to the signal, shifting a zero-frequency of the signal to the first center frequency of the first subband according to the frequency offset.

6. The first apparatus of claim 4, wherein the instructions, when executed by the at least one processor, cause the first apparatus to perform:
performing a down sampling on the signal according to the target sampling rate.

7. The first apparatus of any of claim 1, wherein the instructions, when executed by the at least one processor, cause the first apparatus to perform:
applying a base band process to the signal based on the target sampling rate.

8. The first apparatus of claim 7, wherein the instructions, when executed by the at least one processor, cause the first apparatus to perform:
determining, based on the target sampling rate, at least one of: a time-domain signal measurement, a time-domain signal process, a parameter estimation, or a beamforming process.

9. The first apparatus of claim 7, wherein the instructions, when executed by the at least one processor, cause the first apparatus to perform:
determining, based on the target sampling rate and the sampling rate of the carrier, at least one of: a cyclic prefix or a fast Fourier transform size.

10. The first apparatus of claim 7, wherein the instructions, when executed by the at least one processor, cause the first apparatus to perform:
determining frequency resources for the first subband based on a frequency relationship between the first subband and the carrier.

11-13. (canceled)

14. A method, comprising:
determining, at a first apparatus, a frequency offset between a first center frequency of a first subband and a second center frequency of a carrier, wherein within a time duration, the carrier is split into the first subband for reception and at least one second subband for transmission, and the first subband comprises a set of resource blocks on the carrier;
determining a target sampling rate based at least on a subcarrier spacing and the number of resource blocks in the set of resource blocks; and
based on the frequency offset and the target sampling rate, processing a signal that is received on the first subband from a second apparatus.

15. The method of claim 14, wherein determining the target sampling rate comprises:
determining an operation carrier bandwidth with a same subcarrier spacing as the carrier, and wherein a resource block number of the operation carrier bandwidth is larger than the number of resource block in the set of resource blocks; and
determining the target sampling rate based on the operation carrier bandwidth and a sampling rate of the carrier.

16. The method of claim 15, wherein a ratio between the sampling rate of the carrier and the target sampling rate satisfies power of two.

17. The method of any of claim 14, wherein processing the signal comprises:
applying a digital front end process to the signal based on the frequency offset and the target sampling rate.

18. The method of claim 17, further comprising:
after an analogue to digital conversion is applied to the signal, shifting a zero-frequency of the signal to the first center frequency of the first subband according to the frequency offset.

19. The method of claim 17, further comprising:
performing a down sampling on the signal according to the target sampling rate.

20. The method any of claim 14, wherein processing the signal comprises:
applying a base band process to the signal based on the target sampling rate.

21. The method of claim 20, further comprising:
determining, based on the target sampling rate, at least one of: a time-domain signal measurement, a time-domain signal process, a parameter estimation, or a beamforming process.

22. The method of claim 20, further comprising:
determining, based on the target sampling rate and the sampling rate of the carrier, at least one of: a cyclic prefix or a fast Fourier transform size.

23-29. (canceled)
